(19) United States
(12) Patent Application Publication
(10) Pub. No.: US 2006/0214773 A1
(43) Pub. Date: Sep. 28, 2006

(54) RFID tag singulation

(75) Inventors: James D. Wagner, Tangent, OR (US); Kurt E. Steinke, Seattle, WA (US)

Correspondence Address: PSC SCANNING, INC. - STOEL RIVES LLP;C/O STOEL RIVES LLP, 900 SW 5TH AVENUE, SUITE 2600, PORTLAND, OR, 97204, US

(73) Assignee: PSC Scanning, Inc., Eugene, OR (US)

(21) Appl. No.: 11/351,405

(22) Filed: Feb. 10, 2006

Related U.S. Application Data
(63) Continuation-in-part of application No. 11/055,960, filed on Feb. 10, 2005.

(51) Int. Cl. H04Q 5/22

(52) U.S. Cl. 340/10.2; 340/10.34

(57) ABSTRACT

Disclosed are embodiments of methods, systems, and apparatus for singulating wireless tags. In one embodiment, a power ramping method is provided for tag singulation. This embodiment involves activating a control of an RFID reader for engaging power to begin reading RFID tags. The first reading is taken at a relatively low transmitting power level. If an RFID tag is not detected at the first power level, the power from the RFID reader is increased to a second higher power level. Increasing the transmitting power may be repeated until there is a final read volume where a single RFID tag, or a select number of such tags, is detected. Certain embodiments may provide for ramping the power down as well as up, so that if multiple tags are detected and only the closest tag is desired to be detected, tags can be excluded systematically from the read volume until only a single tag remains.

### RELATED APPLICATION DATA

This application is a continuation-in-part of application Ser. No. 11/055,960, titled “RFID Power Ramping for Tag Singulation” and filed on Feb. 10, 2005, hereby incorporated by reference.

### BACKGROUND

The field of the disclosure relates generally but not exclusively to wireless tag readers and, more particularly, to a method for singulating wireless tags.

Wireless transponders or tags, such as Radio Frequency Identification (RFID) tags, are used in combination with RFID interrogators to identify an object or objects. Typically, when these tags are excited, they produce or reflect a magnetic or electric field at some frequency, which may be modulated with an identifying code or other useful information.

RFID tags may either be active or passive. Active tags have a self-contained power supply. Passive tags require external excitation in order to be read within the read volume of an interrogator or reader. In passive tag systems, the interrogator or reader typically contains a transmitting antenna for sending an exciting frequency signal to the passive tag. The transmitting antenna is often positioned at the portal end adjacent to an antenna for receiving a modulated signal (magnetic or electromagnetic) produced by the excited tag. This modulated signal may identify the tag and, consequently, the object associated with the tag.

The present inventors have recognized problems in the detection of an RFID tag located within the vicinity of other tags. The dimensions of the read volume generated by an interrogator may be such that the read volume contains a large number of tags. Reading RFID tags within the entire read volume can potentially lead to a large number of response collisions (interference) when many tags are present in the volume. Such interference can reduce the accuracy with which each individual tag and successive tags may be read. In addition, because there may be a large volume of space within which to read the tags, it may be difficult for a user of an RFID reader to physically locate a specific RFID tag. In some situations, it may be desirable, for example, to locate the tag closest to the user and/or tag reader.

The conventional method for isolating or singulating tags is to use a narrow-beam antenna. Such antennas are typically larger and require either a different reader or changeable antennas to switch from a normal reading mode to a singulation mode.

### BRIEF DESCRIPTION OF THE DRAWINGS

FIG. 1 is a block diagram illustrating some of the features of one embodiment of a tag singulation system.

FIG. 2 is a flowchart of one embodiment of a tag singulation scheme.

FIG. 3 is a block diagram of another embodiment of a tag singulation system.

FIG. 4A illustrates how a read volume is expanded during tag singulation in one embodiment.

FIG. 4B illustrates how the transmitting power is ramped during tag singulation in one embodiment.

### DETAILED DESCRIPTION OF THE PREFERRED EMBODIMENTS

In the following description, numerous specific details are provided for a thorough understanding of specific preferred embodiments. However, those skilled in the art will recognize that embodiments can be practiced without one or more of the specific details, or with other methods, components, materials, etc.

In some cases, well-known structures, materials, or operations are not shown or described in detail in order to avoid obscuring aspects of the preferred embodiments. Furthermore, the described features, structures, or characteristics may be combined in any suitable manner in one or more embodiments. For example, while the preferred embodiments are described below with reference to a RFID tag, a practitioner in the art will recognize that the principals described herein are viable to other applications.

Disclosed herein are embodiments of methods, systems, and apparatus for tag singulation, or reading a single wireless tag or a group of wireless tags from among a larger group of such tags. As used herein, the term “singulation” does not necessarily imply that only one single tag is read at one time. Rather, as used herein, “singulation” includes a desired resolution of any number of tags, including the case of a single tag being detected and also including the case of multiple tags being detected.

An illustrative embodiment is directed to a method for singulating a wireless tag. In this embodiment, a tag reader is provided. A control on the tag reader is then activated. Activation of the control causes a signal to be transmitted from the RFID tag reader. The signal transmitted from the tag reader is varied in power while the control is activated. The signal may increase continuously or incrementally. The signal may vary upwards and/or downwards until only a single wireless tag is detected.

In another illustrative embodiment, the tag reader initially transmits a signal at a first power level to create a first read volume. The first power level may be relatively low. The reader and/or user then determines whether a response has been received by the tag reader from a wireless tag. If a determination is made that no response has been received from a wireless tag, a subsequent signal at an increased power level over the previous singal, thereby enlarging the read volume, is transmitted. If a determination is made that multiple responses have been received from greater than a given number of wireless tags, characteristics of the previous read volume may be adjusted and a subsequent signal transmitted. In a preferred embodiment, the given number of tags is one, such that if a determination is made that a response is received from more than one tag, the characteristics of the previous read volume are adjusted and a subsequent signal is transmitted.

Characteristics of the read volume may be adjusted by, for example, adjusting the position of the tag reader relative to a wireless tag by moving the reader, moving one or more wireless tags, and/or changing the orientation, frequency, and/or polarization of the reader's transmission antenna. Because wireless tags may have different sensitivities to different polarizations and frequencies, more or less RF (radio frequency) “illumination” may be required for a given tag to respond at a different polarization or frequency, thereby changing the effective read volume for that tag. Thus, in some instances, it may be useful to “fine tune” the read volume by varying the polarization and/or frequency. The characteristics of the previous read volume may alternatively be adjusted by merely decreasing the power of the signal transmitted from the tag reader. The steps of transmitting a subsequent signal at an increased power over the previous signal and/or adjusting characteristics of the read volume may be repeated until only a single wireless tag has been detected within the read volume.

An illustrative embodiment of an RFID reader, which may be capable of implementing one or more of the methods described herein includes an RFID interrogator, means for controlling operation of the reader (such as a processor), an antenna, and power ramping means for varying the power transmitted from the transmission antenna to singulate an RFID tag from a plurality of RFID tags. The power ramping means may comprise a trigger control, and may be implemented using any suitable combination of hardware and/or software. The power ramping means in some embodiments may vary the power transmitted from the transmission antenna upward and downward as needed. In some embodiments, the power ramping means is configured to automatically vary the power upward in response to a determination being made that no response has been received from a wireless tag and is configured to automatically vary the power downward in response to a determination being made that a plurality of responses have been received from a plurality of wireless tags. The power ramping means may further be configured to automatically deactivate upon determining that a response from a single tag has been received or upon determining that the maximum power level has been reached. Additionally or alternatively, the power ramping means may be configured to, upon determining that only a single wireless tag has been detected, read data from the single wireless tag.

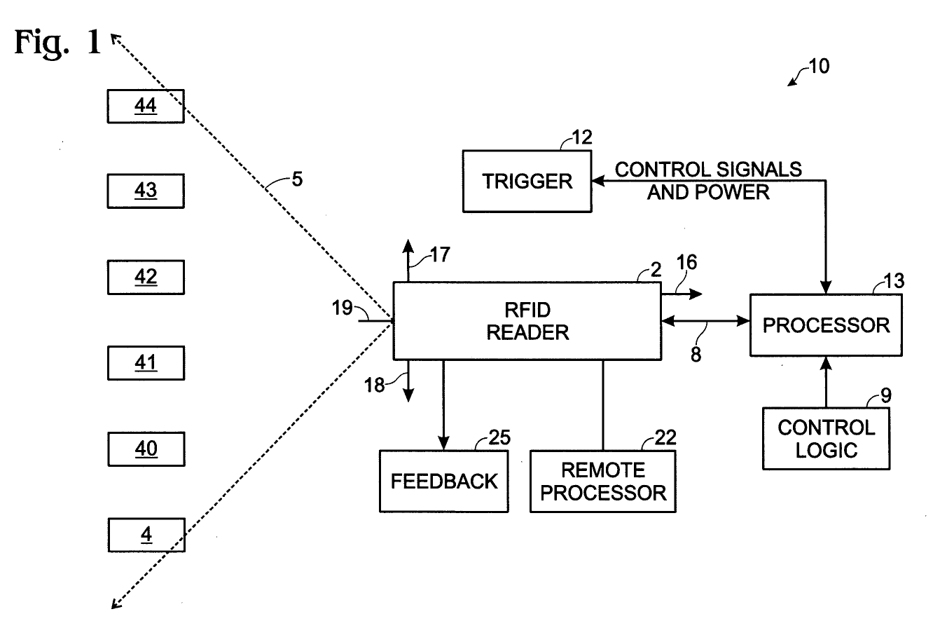

With reference now to the accompanying figures, further details of various embodiments will now be provided. FIG. 1 is a block diagram of an RFID apparatus 10 according to a preferred embodiment. The apparatus 10 uses an RFID reader 2 (also called an “interrogator”) to scan for an RFID tag or set of RFID tags from among a plurality of RFID tags, including tags 4, 40, 41, 42, 43, and 44. The RFID reader 2 may be handheld, such that the RFID reader 2 may be passed over the RFID tags 4, 40, 41, 42, 43, and 44. Alternatively, the RFID reader 2 may be a fixed reader, such that RFID tags 4, 40, 41, 42, 43, and 44 may be passed in front of the reader. The RFID reader 2 may be connected via a USB (universal serial bus) link 8 or other suitable interface to a processor 13. The processor 13 is one example of a means for controlling the operation of a reader. The processor 13 may be any form of processor, controller, or the like and is preferably a digital circuit, such as a general-purpose microprocessor or a digital signal processor (DSP), for example. The processor 13 may be readily programmable; hard-wired, such as an application specific integrated circuit (ASIC); or programmable under special circumstances, such as a programmable logic array (PLA) or field programmable gate array (FPGA), for example.

The reader may alternatively be controlled directly by a host computer. This control scheme would be another example of a means for controlling the operation of a reader. An interface link can be hardwired to an infrared modem connection, an RF modem connection, a combination of the foregoing connections, or any other suitable connections.

The processor 13 may be a microprocessor self-contained within the RFID reader 2 and be capable of storing data, and may, in some embodiments, interface with a remote processor 22. The processor 13 receives control input from control logic 9 for communication with the RFID reader 2. Control logic 9 may be programmable and part of processor 13 or, alternatively, may be separate.

An activation control, such as a trigger control 12, may be used to provide control signals and power to the processor 13. Consequently, the control may implement a singulation scheme to locate a particular RFID tag, such as the closest RFID tag to the location of the reader. For example, the tag 41 may be detected from amongst the RFID tags 4, 40, 41, 42, 43, and 44.

A power-density-time (PDT) control that provides a ramped power control may be accomplished by use of the trigger control 12. A singulation scheme may be initiated, for example, by pulling and holding the trigger control 12. The device may be configured to continue the read for as long as the trigger control 12 is held, up to the point of maximum power. In other words, the trigger control 12 may be pulled to generate a transmission power 170 (FIG. 4B). The transmission power 170 creates a read volume 150 (FIG. 4A), such that a particular tag may be identified from among the tags, 4, 40, 41, 42, 43, and 44.

In addition to the trigger control 12, the system 10 may optionally include a feedback mechanism 25 for indicating to a user a status of the interrogation process. One such mechanism may comprise a progress bar on an LCD display, which may increase, move, or grow as the transmitting power increases. This feedback allows the user to visually determine whether or not the read effort is successful because a singulation read may take longer than a normal read. Alternatively, the feedback mechanism 25 may comprise auditory feedback. Such an auditory feedback mechanism may generate an audible signal when, for example, a single RFID tag has been read, when maximum power has been reached, when a plurality of RFID tags have been read, or when no signal from an RFID tag has been received (and yet sufficient time has elapsed that a signal would have been expected if a tag were present in the read volume). Auditory feedback may include, but is not limited to, increasing a pitch sequence of tone-beeps working with the transmitter power. Yet another example of a feedback mechanism may rely on tactile feedback. For example, the device, or a portion of the device, may be configured to vibrate to provide an indication that, for example, a single wireless tag has been detected. Of course, a combination of auditory, visual, and/or tactile feedback may be employed in some embodiments.

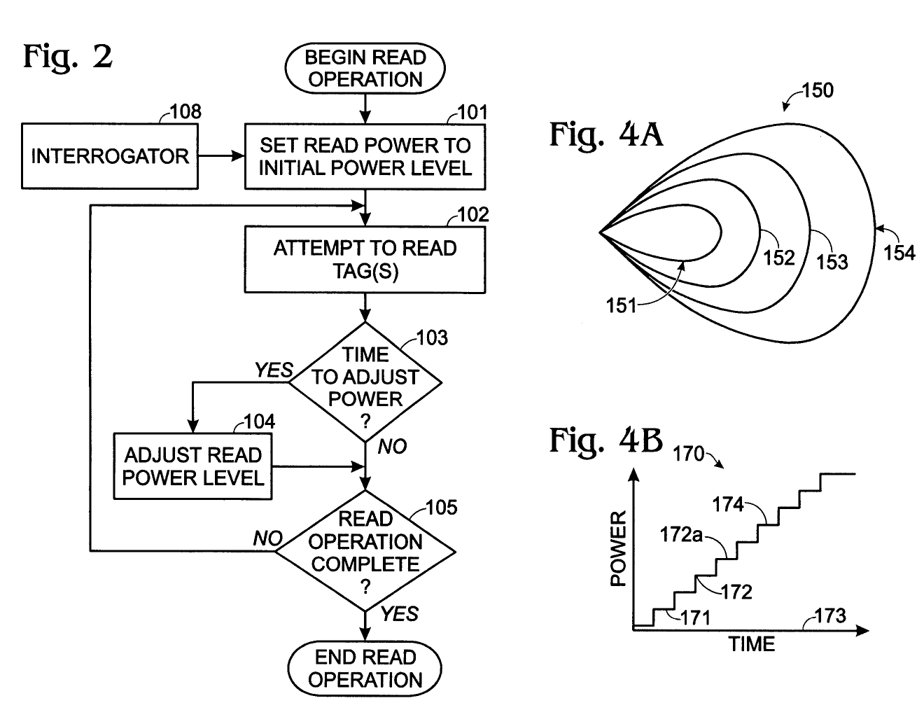

The system 10 of FIG. 1 may be applied to the singulation method diagrammed in FIG. 2. FIG. 2 schematically illustrates a method of RFID power ramping for tag singulation that may involve activating the singulation trigger control 12 of the RFID reader 2. There could be a virtually unlimited number of distinct tags to be read or, alternatively, the tags could be grouped into specific sets of tags, wherein each group of tags contain specific related information.

The user may commence reading tags by pulling on the trigger control 12, thereby transmitting power from the reader 2 at a first low power level 171 (FIG. 4B) and potentially obtaining a first reading of RFID tags within a first read volume 151 (FIG. 4A). The trigger activation may include, but is not limited to, increasing or decreasing a certain amount of pressure on the trigger for a period of time by pulling back on the trigger or intermittently pulling back (rapid increase and decrease of pressure) on the trigger. If a tag is not detected, the transmitting power may be increased to a second power level 172 (FIG. 4B). In some embodiments, this power increase may be accomplished by continued pulling on the trigger control 12. The second power level 172 creates a second read volume 152 for attempting a second reading of RFID tags.

If an RFID tag is still not detected, the transmitting power from the RFID reader 2 may be increased to a third higher power level 172a (FIG. 4B), thereby attempting a third reading of RFID tags within a third read volume 153. At the next step, if a tag has not been singulated, the power level may be increased again to a fourth higher power level 174 to attempt a fourth reading of RFID tags within a fourth read volume 154. If a tag is still not singulated, the continuation of the RFID power ramping may be repeated until, for example, an operator or the device itself makes a determination that a single RFID tag has been detected and read. The trigger control 12 of the RFID reader 2 may be deactivated, such as released, after reading the detected RFID tag. It should be understood that the singulation method may only require a single reading, or may require several readings, depending upon where and in what read volume the user is able to singulate the desired tag.

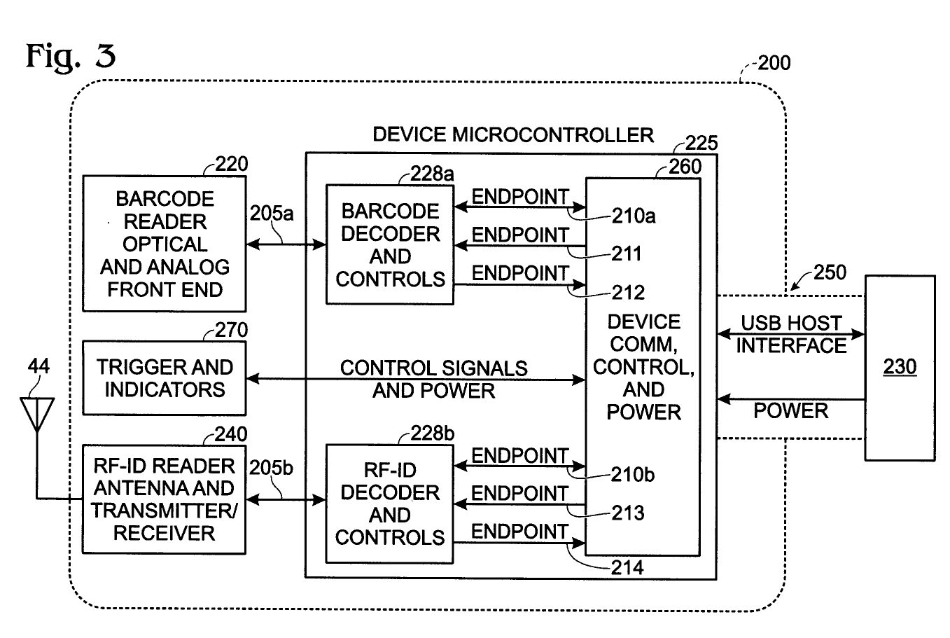

Another singulation scheme may be performed by using, for example, the multifunction reader 200 illustrated in FIG. 3. A singulation trigger control 270 of an RFID reader 228b may be used to initiate the singulation scheme. In this implementation, the trigger control 270 may be pulled and released. If a tag is not singulated, the user may pull and release the trigger 270 again, thereby increasing the transmitting power 170 (FIG. 4B) from the RFID reader 228b to a second higher power level. If a tag is not yet singulated, as previously described, the next step would be to attempt a third reading at a third higher power level. If a tag is still not yet detected, this power ramping sequence may be repeated until an operator identifies a single RFID tag, or a desired group of tags, within a read volume. The trigger control 270 of the RFID reader 228b may be deactivated, either manually or automatically, after reading information from the desired RFID tag(s).

In another embodiment (inventory mode), the singulation scheme may start out transmitting low power 171 (FIG. 4B), thereby querying any RFID tag(s) within the first read volume 151 (FIG. 4A). Any RFID tags within the first read volume 151 may then be turned off. In the subsequent increment of the read volume, specifically, read volume 152, any tags that had been detected in read volume 151 will not respond, so only tags in the newly expanded region of the second read volume 152 will respond to the increased transmitting power 172. The RFID tags in the newly expanded region of the second read volume 152 are also turned off and the transmitting power 170 is again increased. The process may be repeated until maximum power, or some other criteria, is reached. The result is that each successive read queries a relatively thin region or “slice” of space and possible collisions in the RF signal responses of the tags are reduced. Consequently, tags may also be easier to locate, since the region in space generating possible responses is smaller.

Various embodiments described herein may employ several methods or mechanisms to switch between inventory and singulation modes of operation. For example, a user may switch modes by way of a double-click on a trigger control, a long or short trigger pull, a multiple-position trigger (such as a rocker switch), or a force or rate sensitive trigger. Alternatively, a reader may comprise separate triggers, one for the inventory mode and one for the singulation mode. Of course, in other embodiments, a trigger control need not be provided at all. In such embodiments, a button, switch, or the like, or a software menu selection, may be used to switch back and forth between singulation and inventory modes.

Once the user is in the singulation mode, one embodiment involves using a ramping power technique for continuously or incrementally increasing RF transmitting power and thereby increasing the read volume. Possible power ramping techniques include, but are not limited to, linear stepping (FIG. 4B), logarithmic stepping, or continuous ramping. Of course, the rate of increase in continuous power ramping (or incremental) may be linear, or may be logarithmic, exponential, or otherwise. Any of the foregoing power ramping techniques may be used to singulate a tag in response to an activation control, such as a trigger control, being activated. Those having ordinary skill in the art, and having the benefit of the present disclosure, will realize that there may be other techniques to ramp (increase or decrease) power using electronic circuits.

In some embodiments, singulation may be accomplished by a method that first directs the reader antenna, such as an antenna 19 in FIG. 1, into close proximity of a tag, such as tag 42. It should be understood that the antenna 19 may alternatively be moved in the direction of, for example, arrow 17 or arrow 18, if desired. Next, a user of the RFID apparatus may activate the trigger 12 of the RFID reader 2. Upon activation of trigger 12, the reader 2 may issue a read attempt at a relatively low RF transmitting power. The reader 2 may be configured to read or return information on only the first single tag detected. Thus, if the RF power is low enough, and the antenna 19 is positioned near and directed toward the tag 42, the tag 42 may be the only tag read. If the tag 42 is detected, the RFID reader 2 may be configured to power down and/or issue no more reads until the trigger control 12 of the RFID reader 2 is activated again. The tag information may then be presented to the user and/or the processor 13.

If the RF power is not sufficient for a tag to respond, then the RFID reader 2 may issue read attempts at increasing RF power, as described above. Optionally, the reader 2 may be configured to automatically increase to full power and/or inventory mode upon determining that no tags have been read after one or more read attempts.

In some embodiments, when more than one tag is read or detected, the RFID reader may issue read attempts at incrementally or continuously decreasing powers (and decreasing read volumes) until only a single tag is read. As with ramping the transmission power upwards, ramping downwards may be accomplished by manually adjusting the power, or it may occur automatically, upon a determination being made that that a plurality of responses have been received from a plurality of wireless tags, for example. In automated embodiments, the steps, determinations, and power ramping may be provided through the use of, for example, a preprogrammed microprocessor or suitable software.

FIG. 3 depicts a multiple-technology data reader 200 that may be used to implement one or more of the methods described above. The data reader 200 includes the optical and analog front-end components of a bar code reader 220. The reader 200 further includes an antenna 44 and transmitter/receiver components 240 of an RFID interrogator, which are connected to a device microcontroller 225. The microcontroller 225 includes a decoder and control interface 228a for the bar code reader and another control interface 228b for the RFID reader. The decoder and control interfaces 228a and 228b are connected to a device communications control and power unit 260. The multiple-technology data reader 200 also includes a trigger control 270, which may send and receive control signals and power both to and from the device communications control and power unit 260 on the microcontroller 225. The microcontroller 225 is connected to a host computer 230 via USB link 250. Of course, as with each of the components described herein, substitutions may be made, as will be apparent to one having ordinary skill in the art. For example, alternative interfaces other than those shown in FIG. 3 may be used to provide a connection with a host computer.

Examples of other multiple-technology readers that may be used in accordance with the principles described herein can be found in U.S. Pat. No. 6,415,978 titled “Multiple Technology Data Reader for Bar Code Labels and RFID Tags,” which is incorporated herein by reference in its entirety.

The device microcontroller 225 has an input/output endpoint 210a, which enables the host computer 230 to use a default control method to initialize and configure the control unit 228a. Furthermore, the control unit 228a has an endpoint 211, which allows the host computer 230 to send data to the control unit 228a, and an endpoint 212, which allows the control unit 228a to send data to the host computer 230. Data can be sent in either direction between the control unit 228a and the barcode reader subsystem 220 via a serial communications line 205a.

Likewise, reader control unit 228b has an input/output endpoint 210b, which enables the host computer 230 to use a default control method to initialize and configure the reader device interface 228b. In addition, endpoint 213 and endpoint 214, respectively, allow the host computer 230 to receive data from, and send data to, the control unit 228b. Data can be sent in either direction between the reader device interface 228b and the RFID reader subsystem 240 via a serial communications line 205b.

The trigger control 270 may be used to adjust the RF power transmitted by the reader 200. This power adjustment scheme facilitates singulating a particular tag, such as the closest tag to the reader 200, even though more tags may be present within the maximum read volume of the reader 200 and its antenna. In other words, other nearby tags may be excluded through singulation.

For example, if it is desired that the tag closest to the reader be identified, the transmission power generated by the reader may initially be at a relatively low level and may be continuously or incrementally increased for as long as the trigger is activated. RFID readers typically have a software-driven power control available to them. Power ramping therefore may provide a simple, low-cost approach to tag singulation that, for some embodiments, may be implemented in or added to existing tag readers.

To further illustrate with a more specific, but non-limiting, example, if an initial activation of a control, such as trigger control 270, results in a transmission at a power level 6-10 db (decibels) below the maximum allowed power, then, as the trigger control 270 remains activated, it may be configured to increase or “step up” the transmission power by 1-2 db relative to the previous transmission. The increases in power may continue until the maximum power level is reached, particularly if the reader fails to detect any wireless tags within the read volumes created by the previous transmission power levels. Some embodiments of readers may also be configured to decrease in power, either incrementally or continuously. For example, if multiple tags are detected within a particular read volume, and it is desired that only the closest tag be identified, the reader may decrease the power level of the signal it transmits. In some embodiments, the reader may be configured to decrease the power level in finer gradations than were used during the increasing power stage. This scheme may allow for greater precision in detecting just a single tag. The amount of power increase/decrease per step, or rate of continuous power increase/decrease, may vary as desired.

Of course, any of the specifications discussed herein may be varied as desired. For example, how quickly the power is increased and/or decreased during a ramping process, how large the steps between power levels are and how many such levels there are (in embodiments that ramp incrementally), how to switch between inventory and singulation modes and how the reader operates during singulation mode, may all vary widely depending on the context within which the system will be used and the outcomes desired by the system's users.

When the control is released or otherwise deactivated, the reader may be configured to stop its transmission of signals. If the maximum power level is reached before the trigger is released, then the reader may be configured to stop its transmission of signals automatically, or may be configured to continue reading until the control is deactivated manually.

Returning again to one of the specific illustrative embodiments referenced in the accompanying figures, when the trigger control 270 energizes the reader 200, a singulation scheme, such as the scheme illustrated schematically in FIG. 2, may be employed. This singulation scheme would give a high probability of initially reading only those tags that are in close proximity to the antenna (such as the antenna 19 in FIG. 1 or the antenna 44 in FIG. 3). As RF transmission power increases, the read volume grows steadily up to the maximum power level that a particular RFID reader permits. This singulation scheme provides better restriction of the read zone than does, for example, a tight (narrow) antenna beam. In addition, the singulation scheme may be such that it does not require a change from a typical trigger control 270 or switchable antenna. Alternatively, it may be desirable to have a software switch, that is, a dialog box or the like. The singulation scheme may be selectable by using a long trigger pull, a double-click on a trigger, a quick release of a trigger, a software menu selection, another trigger, an automatic selection, or other control mechanism. An automatic selection of the singulation scheme may be implemented by prefacing the read sequence with a single low-power read just sufficient to read a tag touching the antenna.

The singulation scheme shown in FIG. 2 preferably utilizes a power ramping software algorithm, which allows a trigger pull to activate and operate the process. The process begins at step 101, where the initial power level to read RFID tags is established and configured at the reader. The process continues to step 102, wherein the reader is instructed to attempt to read an RFID tag at the current power level. At step 103, a determination is made as to whether the power level used to read tags should be adjusted. For example, the criteria used to make this decision may be based on the amount of time elapsed without a response since a read attempt was made at step 102. Alternatively, antenna sensitivity or a combination of antenna sensitivity and time spent attempting to read a tag may be used. Once it is determined that the power level should be adjusted, step 104 reconfigures the new power setting at the reader. Step 105 determines if the read operation should stop, which may be based on whether a tag has been read, or whether only a single tag has been read. If it is determined that the operation is not yet complete, then the process repeats, beginning again at step 102. Otherwise, the read operation ends, which may involve reporting the tag(s) read, storing and/or sending information received from the tag(s) read, and/or powering down the reader. Alternatively, the steps 102, 103, 104, and 105 may be replaced by a gradual, continuous adjustment of power while attempting to read tag(s), rather than the discrete steps illustrated in FIG. 2.

The singulation scheme may allow for reading one specific RFID tag in the presence of other tags. As discussed above, one illustrative methodology for accomplishing singulation involves systematically increasing the transmitting power. This increased power expands the read volume 150 (FIG. 4A) generated by the reader. The read volume consists of the volume or region of space around the reader antenna in which an RFID tag can be detected and respond. The read volume 150 increases in size as the transmitter power 170 (FIG. 4B) increases. As illustrated in FIG. 4A, a read volume expands similar to the way a balloon expands when air is added to it. As the transmitter power 170 increases, the read volume 150 likewise increases. Thus, as the power level steps up, as shown in FIG. 4B, the read volume grows, as shown by the “balloons” depicted in FIG. 4A, thereby covering a greater region in which RFID tags can be read.

In a preferred configuration, a reader may be provided with a software-driven transmitter-power control, such as, for example, one that creates incremental or stepped power ramping, as shown in FIG. 4B. The power steps may be on the order of about 1 db or less starting, for example, at less than about 0.1W. (The maximum power allowed by the Federal Communications Commission for RFID is 1W). When a singulation scheme is initiated with a reader, the transmitter power may be started at a first low level, such as level 171 in FIG. 4B. The reader may then attempt to read a tag at a first read volume 151 (FIG. 4A), which is the maximum volume that can be read at the first low power level 171. The singulation scheme may then pause for a short period, but long enough for a tag to respond, should any tags be detected within the read volume. Once it has been determined that a response has not been received from a wireless tag, the power level may be increased by a particular increment with increasing time 173 (FIG. 4B).

For example, the transmitter power could be increased to a second power level 172 (FIG. 4B), thereby creating a second read volume 152 (FIG. 4A). The reader may then attempt to read tags within volume 152, which is the maximum volume that can be read at the second level 172. The singulation scheme may then be repeated until, for example, maximum power is reached or the user terminates the scheme and/or shuts down the reader. In some implementations, early termination may occur because a single tag (likely the closest tag) has been detected. The read volume 150 (FIG. 4A) may initially encompass only tags relatively close to the reader. As shown in FIGS. 4A and 4B, as the RF transmitting power 170 increases, the read volume expands to provide sensing read volumes 151, 152, 153, and 154. Likewise, as the read volume grows, the number of tags within the volume may increase.

Yet another method to singulate a wireless tag involves performing a “successive approximation” search. In a successive approximation search, a tag reader may be configured to initially transmit a signal at minimum power. If no wireless tags are found, the device may step up the signal power incrementally or continuously, as described above. Alternatively, the device may immediately step up to full transmitting power. As soon as only a single tag is found, the method may be stopped and the tag read. If no tag is found at full power, the method may be stopped and a message, such as “No Tag Found,” returned to the user. If multiple tags are found at maximum power, then the power may be cut by a particular amount. The power may then be ramped further down (or up) by a factor of the previous increment, and thereby with successively smaller steps, depending on whether no tag or multiple tags are found until only a single tag responds.

As one specific example, if no tags are found at the minimum power level, the power level is ramped to full power. If multiple tags are found at full power, the power is decreased to half of the maximum. If multiple tags are found again, the power is decreased to one-fourth of the maximum power. If instead no tags are detected, the power is increased by half of the previous step to three-fourths of the maximum power level. The next step changes the power level by ⅛ of the maximum power level, either up or down depending on whether multiple tags or no tags were detected in the previous attempt. This process may continue until a result is obtained with the desired precision.

The algorithms for operating the methods and systems illustrated and described herein can exist in a variety of forms both active and inactive. For example, they can exist as one or more software or firmware programs comprised of program instructions in source code, object code, executable code or other formats. Any of the above can be embodied on a computer-readable medium, which include storage devices and signals, in compressed or uncompressed form. Exemplary computer-readable storage devices include conventional computer system RAM (random access memory), ROM (read only memory), EPROM (erasable, programmable ROM), EEPROM (electrically erasable, programmable ROM), flash memory and magnetic or optical disks or tapes. Exemplary computer-readable signals, whether modulated using a carrier or not, are signals that a computer system hosting or running a computer program can be configured to access, including signals downloaded through the Internet or other networks. Concrete examples of the foregoing include distribution of software on a CD ROM or via Internet download. In a sense, the Internet itself, as an abstract entity, is a computer-readable medium. The same is true of computer networks in general.

The terms and descriptions used herein are set forth by way of illustration only and are not meant as limitations. Those skilled in the art will recognize that numerous variations and modifications can be made to the details of the above-described embodiments without departing from the underlying principles of the invention. The scope of the invention should therefore be determined only by the following claims—and their equivalents—in which all terms are to be understood in their broadest reasonable sense unless otherwise indicated.

1. A method for singulating a wireless tag, comprising the steps of:
transmitting a signal at a first power level to create a read volume;
attempting to receive a response from a wireless tag; and
determining whether a response has been received,
wherein, if a determination is made that no response has been received, transmitting a subsequent signal at an increased power level over the previous signal enlarging the read volume.

2. The method of claim 1, wherein, if a determination is made that multiple responses have been received from greater than a given number of wireless tags, further comprising:
adjusting characteristics of the previous read volume and transmitting a subsequent signal in accordance with the adjusted characteristics.

3. The method of claim 2, further comprising:
repeating the steps of transmitting a subsequent signal at an increased power over the previous signal and/or adjusting the characteristics of the previous read volume until the given number of wireless tags have been detected within the read volume.

4. The method of claim 3, wherein the method is performed by a tag reader, and wherein the determination that no response has been received, and the determination that multiple responses have been received from greater than the given number of wireless tags, are made automatically by the tag reader.

5. The method of claim 3, wherein the given number of wireless tags is one.

6. The method of claim 3, wherein the given number of wireless tags is selected via user input.

7. The method of claim 3, wherein the given number of wireless tags is a single tag, the method further comprising:
upon determining that only a single wireless tag has been detected, reading data from the single wireless tag.

8. The method of claim 3, wherein the method is performed by a tag reader, and wherein the method is initiated by activating a trigger control on the tag reader.

9. The method of claim 8, wherein the step of activating the trigger control comprises at least one action selected from the group consisting of a trigger pull, a double-click on the trigger, a release of the trigger, and a software menu selection.

10. The method of claim 3, wherein the method is initiated by activating a software control.

11. The method of claim 3, wherein the method is performed by a tag reader, and wherein adjusting characteristics of the previous read volume comprises adjusting a position of the tag reader relative to a wireless tag.

12. The method of claim 3, wherein adjusting characteristics of the previous read volume comprises decreasing the power of the signal transmitted.

13. The method of claim 12, further comprising automatically decreasing the power transmitted in response to determining that responses have been received from greater than the given number of wireless tags.

14. A method for singulating a wireless tag, comprising the steps of:
providing an RFID tag reader;
activating a control on the RFID tag reader, wherein activation of the control causes a signal to be transmitted from the RFID tag reader, wherein a power level of the signal is varied while the control is activated until only a single wireless tag is detected; and
deactivating the control.

15. The method of claim 14, wherein the signal varies in power continuously.

16. The method of claim 14, wherein the signal varies in power incrementally.

17. The method of claim 14, wherein the control is automatically deactivated in response to receiving a signal from only a single RFID tag.

18. The method of claim 14, wherein the control is automatically deactivated in response to reaching a maximum power level.

19. The method of claim 14, wherein the control is automatically deactivated in response to reaching a minimum power level.

20. The method of claim 14, wherein the control comprises a trigger control.

21. A data reader comprising:
means for controlling the operation of the data reader;
an antenna; and
power ramping means for varying a power level transmitted from the antenna to singulate an RFID tag from a plurality of RFID tags.

22. The data reader of claim 21, wherein the power ramping means comprises a trigger control.

23. The data reader of claim 22, further comprising a second trigger control, wherein the second trigger control is for operating the data reader in an inventory mode, and wherein the trigger control is for operating the data reader in a singulation mode.

24. The data reader of claim 22, wherein the trigger control is configured to initiate incrementally varying the power transmitted from the antenna upon detecting at least one action selected from the group consisting of a long trigger pull, a double-click on the trigger, and a quick release of the trigger.

25. The data reader of claim 21, wherein the power ramping means comprises a software control.

26. The data reader of claim 25, wherein the software control resides on the data reader.

27. The data reader of claim 21, wherein the power ramping means is configured to singulate the RFID tag by successive approximation.

28. The data reader of claim 21, wherein the means for controlling the operation of the data reader comprises a processor.

29. The data reader of claim 21, further comprising a feedback mechanism for indicating to a user a status of the interrogation.

30. The data reader of claim 29, wherein the feedback mechanism comprises a visual indication of the status of the interrogation.

31. The data reader of claim 29, wherein the feedback mechanism comprises an audible indication of the status of the interrogation.

32. The data reader of claim 29, wherein the feedback mechanism comprises a tactile indication of the status of the interrogation.

33. The data reader of claim 29, wherein the status comprises at least one status item selected from the group consisting of: an indication of the power level currently being transmitted by the data reader, an indication that maximum power on the data reader has been reached, an indication of a signal from a single RFID tag being received, an indication of signals from a plurality of RFID tags being received, and an indication that no signal from an RFID tag has been received.

34. The data reader of claim 21, wherein the power ramping means is configured to incrementally vary the power transmitted from the antenna.

35. The data reader of claim 21, wherein the power ramping means is configured to vary the power transmitted from the antenna upward and downward.

36. The data reader of claim 35, wherein the data reader is configured to automatically vary the power upward in response to a determination being made that no response has been received from a wireless tag and is configured to automatically vary the power downward in response to a determination being made that a plurality of responses have been received from a plurality of wireless tags.

37. A data reader comprising:
a transmitter including an antenna, the transmitter capable of transmitting from the antenna an RF signal at multiple power levels; and
a processor connected to the transmitter, the processor configured to cause the transmitter to vary the power of the RF signal transmitted from the antenna to singulate an RFID tag from a plurality of RFID tags.
